(19) United States
(12) Patent Application Publication
(10) Pub. No.: US 2007/0096505 A1
(43) Pub. Date: May 3, 2007

(54) MODULAR ASSEMBLY FOR RECREATIONAL VEHICLE

(76) Inventor: Brian P. Haack, Charlotte, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 11/538,283

(22) Filed: Oct. 3, 2006

Related U.S. Application Data
(60) Provisional application No. 60/723,535, filed on Oct. 4, 2005.

(51) Int. Cl. B60P 3/355; E04B 1/61; E04B 1/14

(52) U.S. Cl. 296/165; 296/173; 296/193.04; 52/79.1; 52/270

(57) ABSTRACT

A lightweight modular construction for use as a slide-out structure in a recreational vehicle is provided. The slide-out structure comprises a floor, a structural wall, and a roof. The floor, the roof, and the wall structure may include a plurality of reinforced foam panels, connected together in a modular fashion. A first and a second elongated bracket interconnect the floor and the structural wall by an interlocking dovetail connection. A header bracket interconnects the structural wall and the roof.

### CROSS REFERENCE TO RELATED APPLICATION

This application claims the benefit of application Ser. No. 60/723,535 filed Oct. 4, 2005, the advantages and disclosure of which are hereby incorporated by reference.

### BACKGROUND OF THE INVENTION

1. Field of the Invention

The subject invention relates to a vehicle including a slide-out structure, and more specifically to the construction of the slide-out structure.

2. Description of the Prior Art

Recreational vehicles, such as camper trailers, motor homes, etc., are sometimes provided with slide-out structures. The slide-out structure is moveable outwardly from the vehicle by a servo motor to provide additional space when the vehicle is stationary and in use; and retractable into the recreational vehicle during transportation of the recreational vehicle.

The slide-out structure includes a floor, three walls, and a roof. The construction of the slide-out structure is similar to that of a traditionally framed house, in which the walls are first roughed in using dimensional lumber and then mounted to the floor. The roof is mounted over joists in a traditional fashion. Siding is affixed to the exterior of the walls and an interior wall covering is placed over the inside of the walls. Such a construction technique is very labor intensive and therefore costly.

A modular construction technique is disclosed in U.S. Pat. No. 6,745,470 which describes a semi-trailer having walls constructed from modular panels. The panels forming the walls include an outer covering, a polymeric core, and an inner covering. The panels are connected together through a tongue and groove configuration disposed along the sides of the panels. The trailer includes a floor and a roof, each preferably manufactured from a metal material, and each defining a channel for supporting the walls therein with the walls sandwiched between the floor and the roof.

### SUMMARY OF THE INVENTION AND ADVANTAGES

The subject invention provides a vehicle comprising a body, which defines an opening. A slide-out structure is disposed within the opening and is moveable laterally relative to the body. The slide-out structure includes a floor and a structural wall extending from the floor. The structural wall includes a sill plate, a top plate, and a plurality of studs extending between the sill plate and the top plate. A first elongated bracket is mounted to one of the floor and the structural wall and defines a female channel. A second elongated bracket is mounted to one of the floor and the structural wall and defines a male projection. The male projection is complimentary in configuration to the female channel and is disposed within the female channel in interlocking engagement with the female channel for connecting the floor and the structural wall.

Accordingly, the subject invention provides a modular construction technique. The panels are quickly connected to the floor by an interlocking dovetail connection between the female channel and the male projection of the first and second elongated brackets respectively. Therefore, the modular construction technique provided by the subject invention reduces the time to assemble the slide-out structure, thereby lowering the cost of producing the slide-out structure.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a perspective view of a vehicle having a slide-out structure;

FIG. 2 is an end view of a panel;

FIG. 3 is an exploded perspective view of a plurality of wall panels aligned in a straight wall segment;

FIG. 4 is side view of the wall panel;

FIG. 5 is a fragmentary perspective view of a first elongated bracket and a second elongated bracket interconnecting a floor and a structural wall of the structure;

FIG. 6 is a fragmentary perspective view showing a plurality of adjoining flooring panels of the floor interconnected by a flooring connector;

FIG. 7 is a perspective view of one of the flooring panels of the floor;

FIG. 8 is a fragmentary perspective view of the flooring connector;

FIG. 9 is a perspective view of the roof showing a plurality of roofing panels interconnected together;

FIG. 10 is a perspective view of one of the roofing panels of the roof;

FIG. 11 is a fragmentary perspective view of a first U-shaped roofing connector for connecting adjoining roofing panels;

FIG. 12 is a fragmentary perspective view of the first U-shaped roofing connector engaged with adjoining roofing panels and a roof bracket;

FIG. 13 is a fragmentary end view of a second I-shaped roofing connector engaged with adjoining roofing panels;

FIG. 14 is a fragmentary perspective view of the second I-shaped roofing connector for connecting adjoining roofing panels;

FIG. 15 is a perspective view of the support bracket;

FIG. 16 is a fragmentary perspective view of the U-shaped roofing connector and the I-shaped roofing connector interconnecting adjoining roofing panels and a support bracket connecting the U-shaped roofing connector and the I-shaped roofing connector;

FIG. 17 is an end view of the first elongated bracket;

FIG. 18 is an end view of the second elongated bracket;

FIG. 19 is a fragmentary perspective view of the first elongated bracket and the second elongated bracket in interlocking engagement;

FIG. 20 is a fragmentary perspective view of the first elongated bracket and the second elongated bracket in interlocking engagement viewed from an opposing direction relative to FIG. 19;

FIG. 21 is a fragmentary perspective view of the roof bracket;

FIG. 22 is a fragmentary perspective view of the roof bracket interconnecting the roof and the structural wall;

FIG. 23 is a fragmentary perspective view of a support for disposition within the floor;

FIG. 24 is an alternative embodiment of the structure;

FIG. 25 is a fragmentary perspective view of an upper portion of the structural wall of the alternative embodiment of the structure;

FIG. 26 is another fragmentary perspective view of a lower portion of the structural wall of the alternative embodiment of the structure; and

FIG. 27 is an exploded fragmentary perspective view of the roof and the structural wall of the alternative embodiment of the structure.

### DETAILED DESCRIPTION OF THE INVENTION

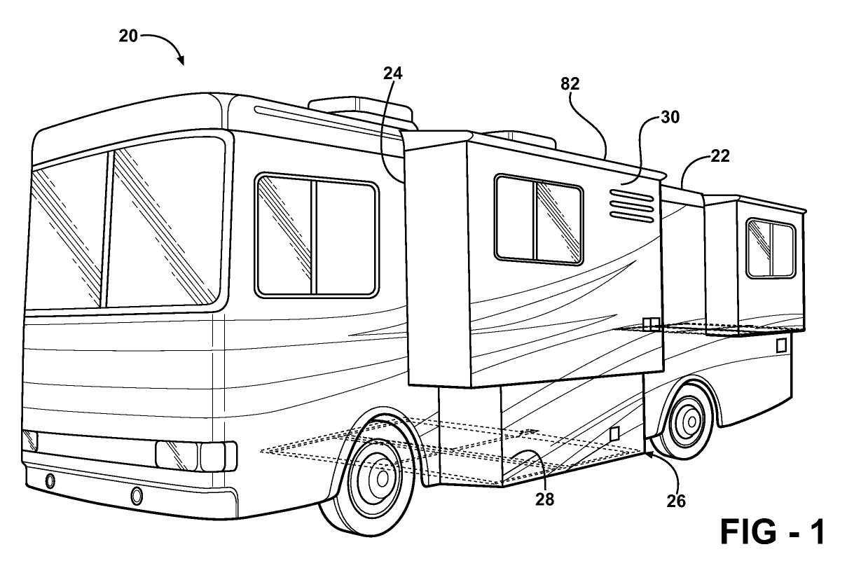

Referring to the Figures, wherein like numerals indicate corresponding parts throughout the several views, a vehicle is shown generally at 20 in FIG. 1. The vehicle 20 includes a body 22, which defines an opening 24. A slide-out structure, shown generally at 26, is disposed within the opening 24 and is moveable laterally relative to the body 22 of the vehicle 20. While the subject invention is primarily discussed herein related to the slide-out structure 26 disposed within the vehicle 20, it should be understood that the subject invention disclosed herein may also be practiced with other small structures 26 not integrated into the vehicle 20, such as a storage shed.

The slide-out structure 26 includes a floor 28 and a structural wall 30 extending from the floor 28. The structural wall 30 may include several different wall segments arranged to form the outer periphery of the slide-out structure 26. Typically, the structural wall 30 includes three wall segments; two wall segments parallel each other with one wall segment extending therebetween, with the slide-out structure 26 being open to an interior of the vehicle 20 as is well known in the art.

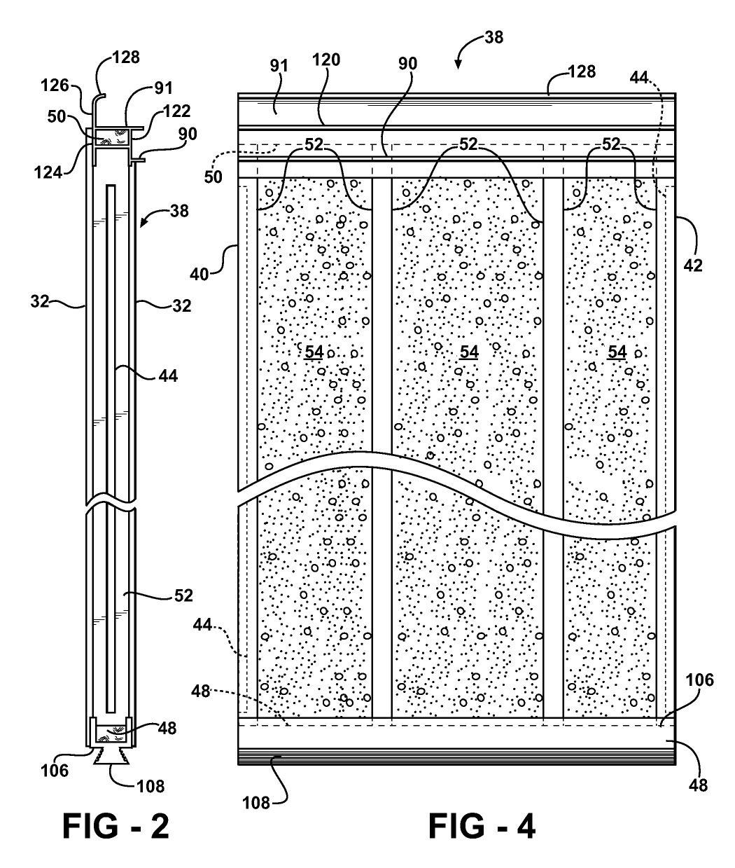

Referring to FIG. 2, the structural wall 30 may include a covering layer 32 bonded or mechanically affixed to the structural wall 30. The covering layer 32 may include an exterior siding material, such as aluminum or vinyl if disposed on an exterior of the slide-out structure 26 or may include an interior siding material, such as a plastic or gypsum board if disposed on an interior of the slide-out structure 26. It should be understood that the covering layer 32, whether for the interior or exterior of the slide-out structure 26, may include other materials not specifically mentioned herein.

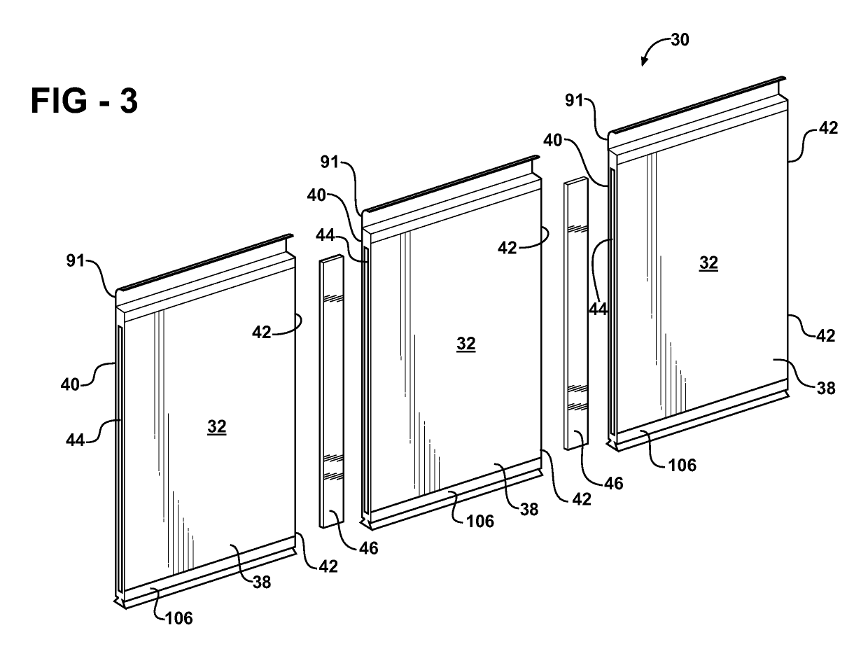

Referring to FIG. 3, each wall segment of the structural wall 30 may include a plurality of panels 38 positioned adjacent each other along a plane, i.e., forming a straight wall segment. Referring also to FIG. 4, each of the plurality of panels 38 includes a first side edge 40 and a second side edge 42 defining a slot 44 that extends upward along a height of each of the panels 38. If the wall segment includes more than one panel 38, a spline 46 is partially disposed within each of the slots 44 of the adjacent panels 38 to interconnect the adjacent panels 38 of the structural wall 30. Accordingly, each spline 46 is partially disposed within the slot 44 of the first side edge 40 of one panel 38 and partially disposed within the slot 44 of the second side edge 42 of an adjacent panel 38, thereby connecting the panels 38 and restraining the panels 38 from lateral movement relative to each other. As shown in FIG. 1, the parallel side wall segments of the slide-out structure includes a single panel 38 and the back wall segment includes multiple panels 38 with a window cutout therein.

Each panel 38 of the structural wall 30 includes a sill plate 48, a top plate 50, and a plurality of studs 52 extending between the sill plate 48 and the top plate 50. The sill plate 48, the top plate 50, and the studs 52 are preferably manufactured from lumber, and more preferably from dimensional lumber having dimensions of two inches (2″) in by two inches (2″). However, it should be understood that the sill plate 48, the top plate 50, and the studs 52 may be manufactured from dimensional lumber having dimensions other than described herein, and may comprise materials other than lumber, such as a plastic or metal material. The structural wall 30 further includes a foam core 54 disposed about the sill plate 48, the top plate 50, and the plurality of studs 52. Preferably, the foam core 54 at least partially encapsulates, the sill plate 48, the top plate 50 and the plurality of studs 52. This may be accomplished, for example, by placing the sill plate 48, the top plate 50, and the studs 52 in a mold and injecting the foam therein to encapsulate the panel 38, thereby forming a lightweight reinforced foam panel 38. Alternatively, the foam core 54 may comprise sheets cut to fit and placed between the sill plate 48, the top plate 50, and the studs 52, and sandwiched between the interior covering layer 32 and the exterior covering layer 32. It should be understood that the foam core 54 is optional and may therefore be eliminated from the panel 38 if desired.

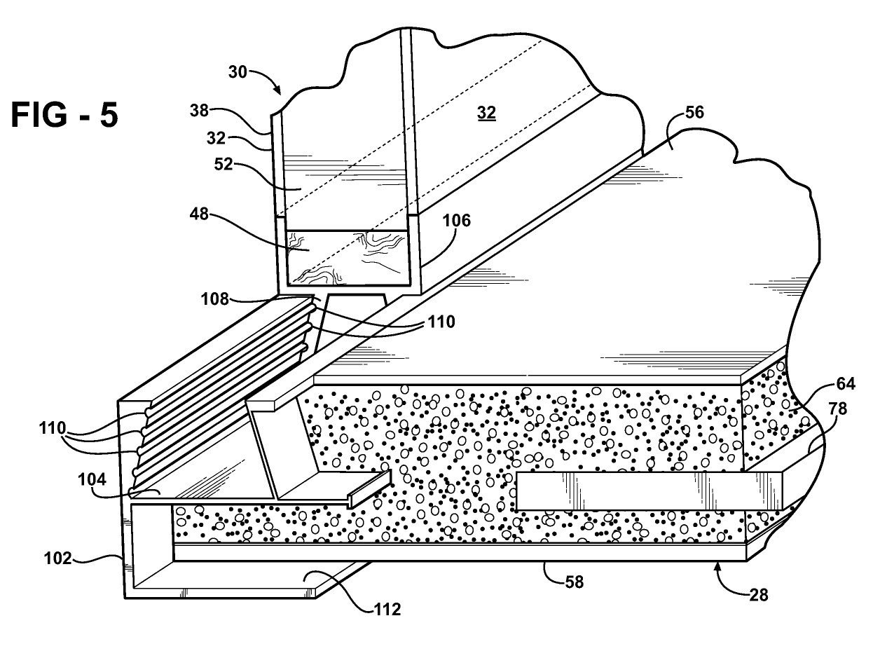

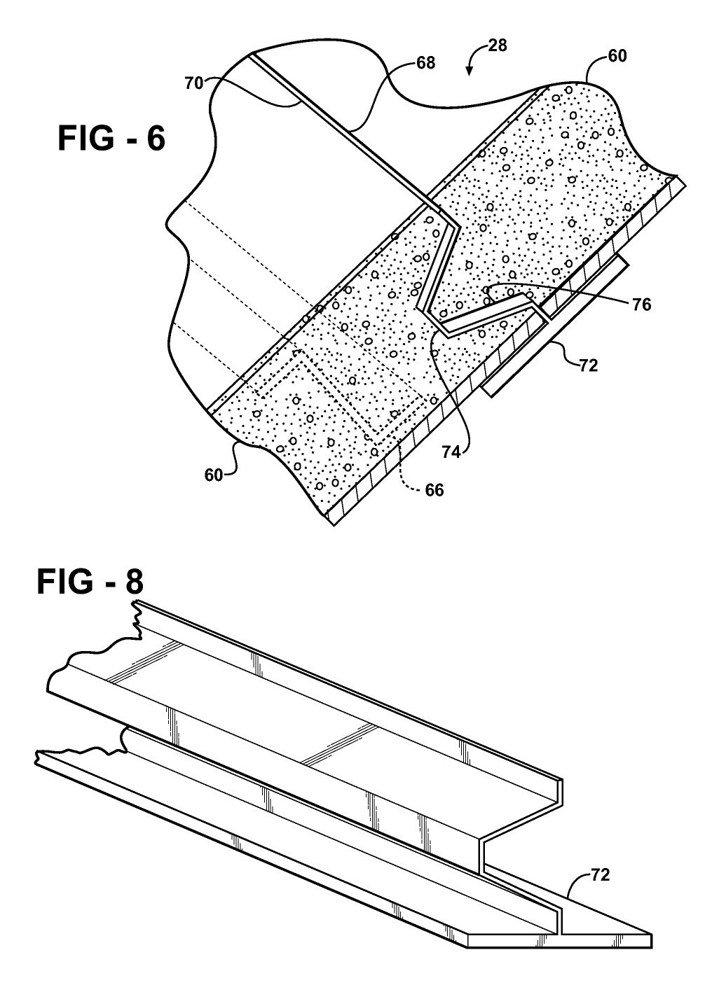

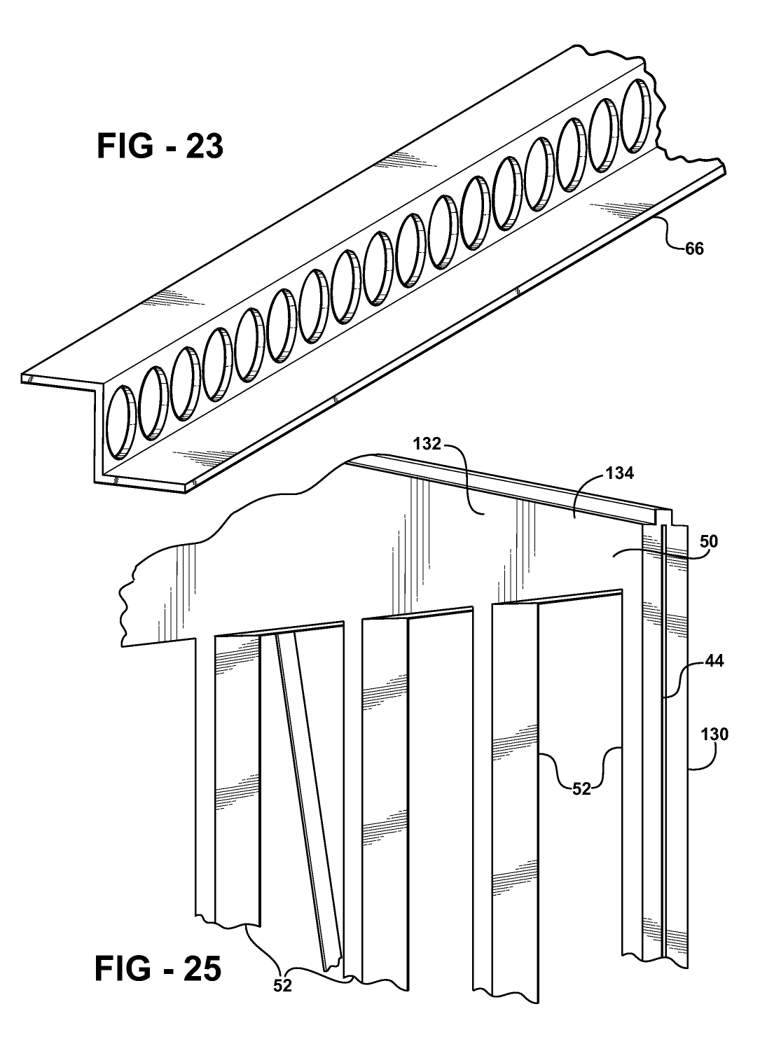

Referring to FIGS. 5 and 6, the floor 28 comprises a foam center 64 and may include a support 66 encapsulated within the foam center 64, as shown in FIG. 6. Referring to FIG. 23, the support 66 has a Z shaped cross section, and provides additional bending strength to the floor 28. It should be understood that the support 66 may include some other cross sectional shape such as a square tube, a round tube, an I beam, a C channel, or some other shape and still fall within the scope of the claims. The support 66 comprises a rigid material, such as a hard plastic or a metal. However, it should be understood that some other material may be utilized for the support 66 that is capable of providing the necessary additional bending and shear strength to the floor 28. Referring back to FIGS. 5 and 6, an upper support sheet 56 and a lower support sheet 58 sandwich the foam center 64 therebetween. The upper support sheet 56 and the lower support sheet 58 preferably include a fiberglass material, but may also include some other rigid material, such as an oriented strand board or a plywood, capable of providing shear and bending strength to the foam center 64 and protect the foam center 64 of the floor 28 from damage.

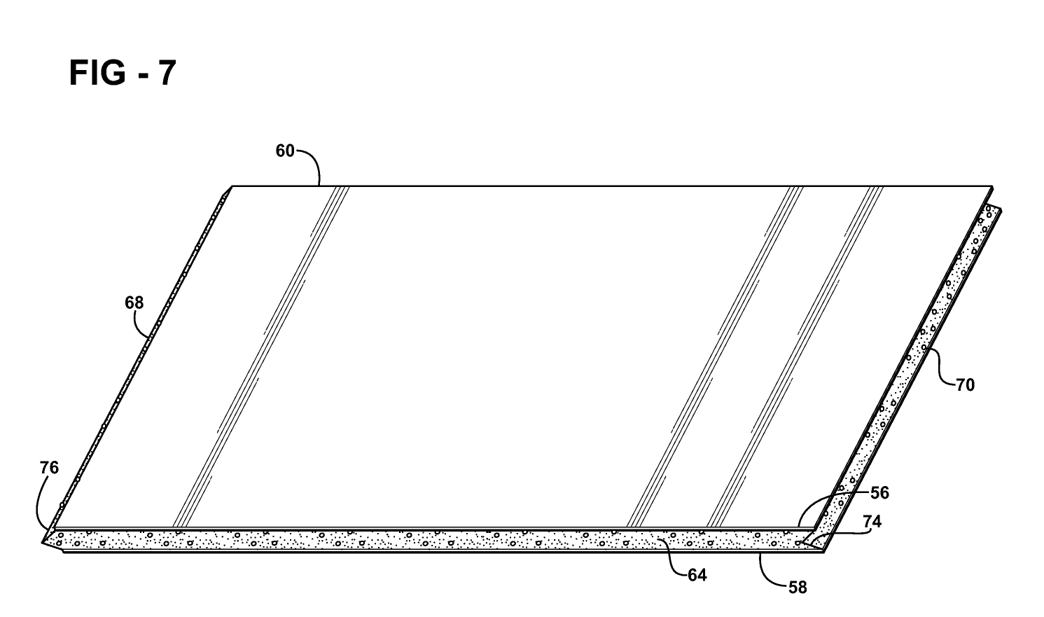

As best shown in FIG. 6, the floor 28 may include a plurality of flooring sheets 60 aligned adjacent each other in a generally horizontal plane. Referring also to FIGS. 7 through 8, each of the flooring sheets 60 includes a first lateral edge 68 and a second lateral edge 70, with a flooring connector 72 interconnecting the first lateral edge 68 and the second lateral edge 70 of the adjacent flooring sheets 60. Preferably, one of the first lateral edge 68 and the second lateral edge 70 includes a lateral notch 74 and the other of the first lateral edge 68 and the second lateral edge 70 includes a lateral ridge 76 having a shape complimentary to the lateral notch 74. The lateral notch 74 and the lateral ridge 76 of the adjacent flooring sheets 60 are in interlocking engagement to secure the adjacent flooring sheets 60 together and restrain the adjacent flooring sheets 60 from vertical movement relative to each other. As shown in FIG. 6, the flooring connector 72 includes a shape complimentary to the lateral notch 74 and the lateral edge and disposed therebetween to increase the rigidity of the connection between adjacent flooring sheets 60. It should be understood that the shape of the lateral notch 74, the shape of the lateral ridge 76, and the shape of the flooring connector 72 may differ from that described herein and still fall within the scope of the claims.

Referring back to FIG. 5, the slide-out structure 26 further comprises a mounting plate 78 attached to the floor 28. An extension mechanism 80, shown schematically in FIG. 1, is coupled to the mounting plate 78 for moving the slide-out structure 26 laterally relative to the body 22. The mounting plate 78 may include a rigid material, such as a metal material or a wood material, capable of transmitting forces between the extension mechanism 80 and the slide-out structure 26. There are many different extension mechanisms 80 known in the art capable of extending and retracting the slide-out structure 26 from the body 22 that may be incorporated into the vehicle 20. Accordingly, the extension mechanism 80 is not described in detail herein. It should be understood that when the subject invention is practiced as a stand-along structure 26, not in relation to the vehicle 20, then the mounting plate 78 and the extension mechanism 80 are not included in the structure 26.

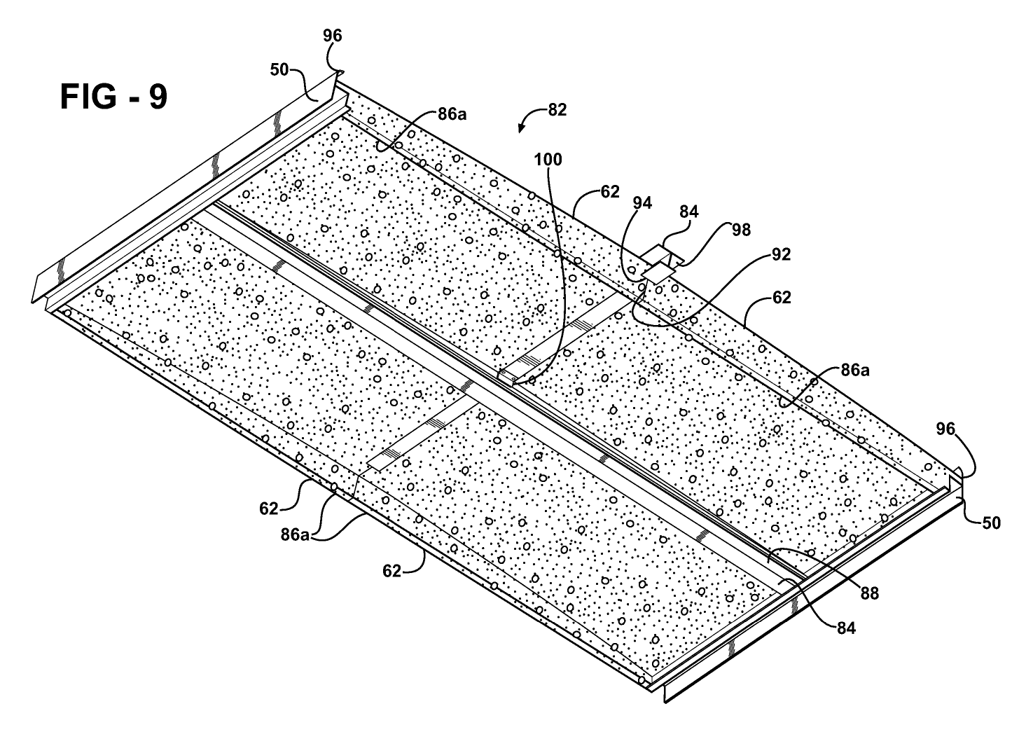

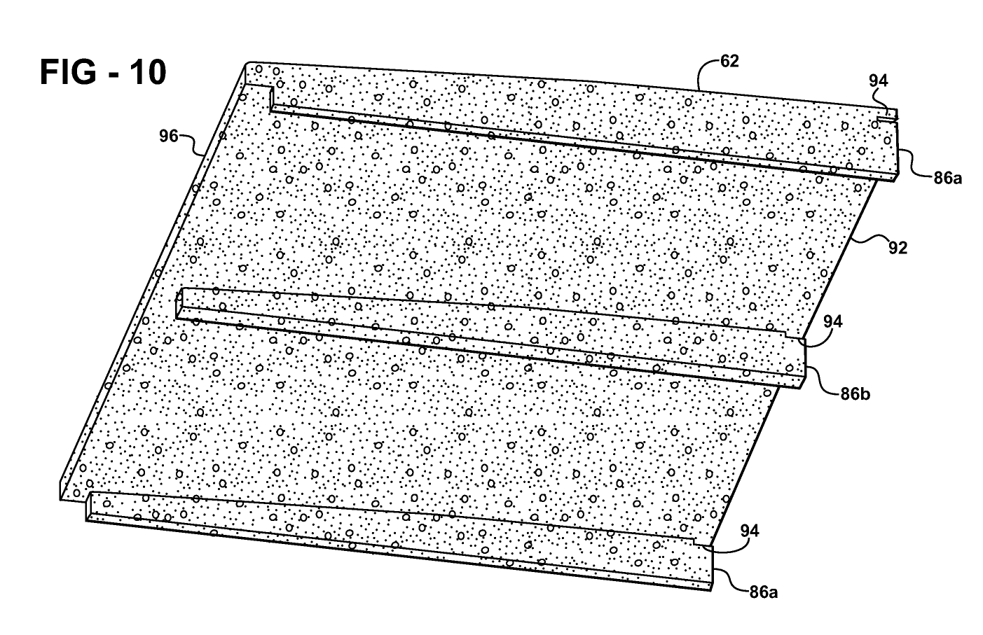

Referring to FIG. 9, the slide-out structure 26 further includes a roof 82 in spaced relationship relative to the floor 28. The roof 82 comprises a foam, and may include a plurality of roofing sheets 62 aligned adjacent each other, with at least one roofing connector 84 interconnecting the roofing sheets 62. Also referring to FIG. 10, the roofing sheets 62 each include a plurality of ribs 86 in spaced relationship extending across a width of each of the roofing sheets 62. As best shown in FIG. 10, each roofing sheet 62 includes three ribs 86, one rib 86a at each end of the roofing sheet 62 and one rib 86b located at the approximate med-section of the roofing sheet 62. The ribs 86a located at each end of the roofing sheet 62 includes a thickness approximately half that of a thickness of the rib 86b located at the center of the roofing sheet 62 so that two outer ribs 86a of adjacent roofing sheets 62, when positioned side by side, have an approximate thickness equal to the center rib 86b. It should be understood that the roofing panels 38 may include any number of ribs 86 and the scope of the claims is not limited by the exact configuration of the ribs 86 described herein.

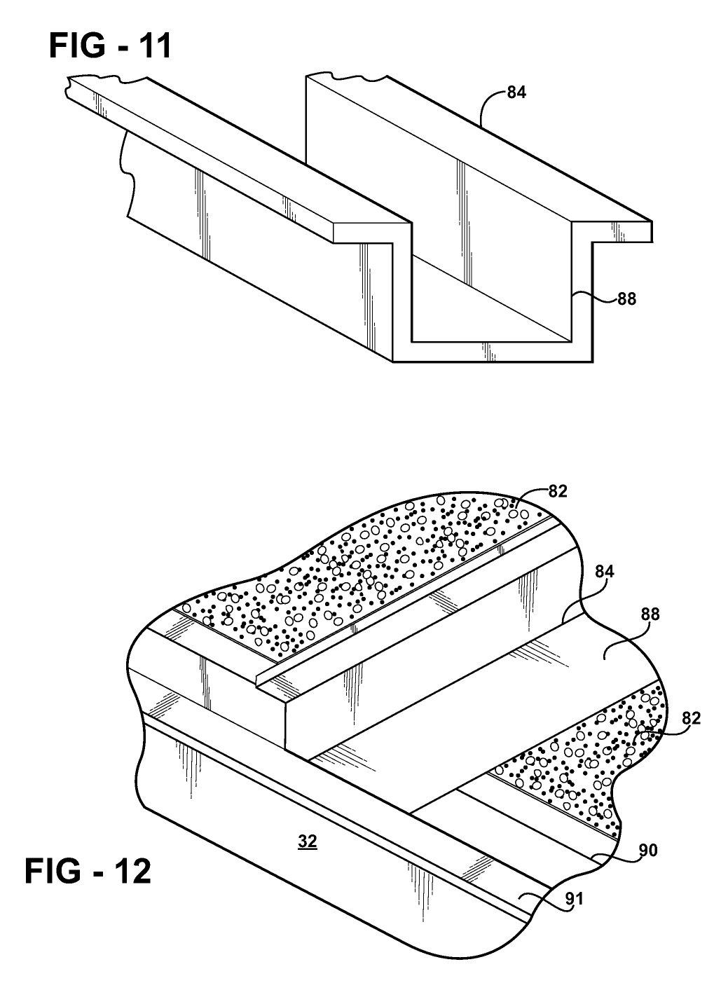

Referring to FIGS. 11 and 12, with reference to FIG. 9, the roofing connector 84 includes a first roofing connector 88 having a U-shaped cross section. The U-shaped roofing connector 88 is seated on a ledge 90 presented by the a roof bracket 91, described in detail below. The U-shaped roofing connector 88 supports at least one rib 86 of the roofing sheets 62 therein. Accordingly, the U-shaped roofing connector 88 may support a single rib, e.g., the center rib 86b, or the U-shaped roofing connector 88 may support a pair of ribs, e.g., two adjacent outer ribs 86a on adjoining roofing sheets 62.

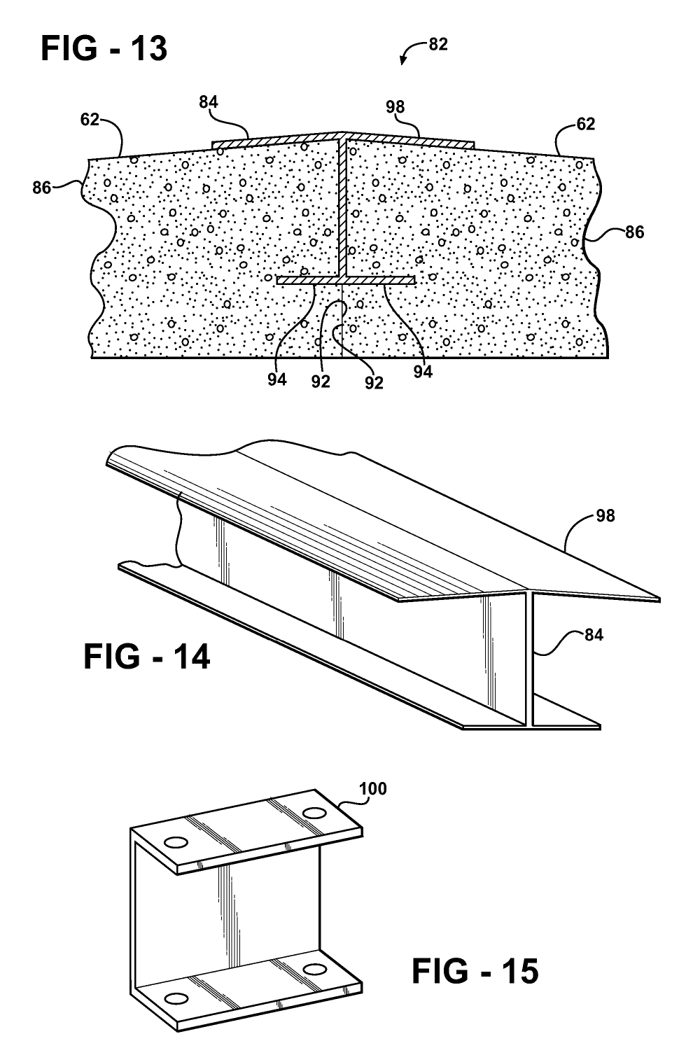

Referring to FIGS. 10 and 13, the roofing sheets 62 include a thickened edge 92, with an alignment slot 94 extending through each rib 86 at the thickened edge 92. The thickened edge 92 is opposite a narrow edge 96, which is positioned near the outer wall of the roof bracket 91. Accordingly, two roofing sheets 62 may be positioned “back to back”, with the thickened edge 92 of one roofing sheet 62 abutting the thickened edge 92 of the other roofing sheet 62, to form a roof 82 that includes a crowned cross section defining a ridge running the length of the roof 82. As shown in FIG. 13 and 14, the roofing connector 84 further includes a second roofing connector 98 having an I-shaped cross section. A portion of the I-shaped roofing connector 98 is disposed within the alignment slot 94 and interconnects the adjoining roofing sheets 62. In other words, a lower flange of the I-shaped roofing connector 98 is disposed in the alignment slots 94 of the adjacent roofing sheets 62, and an upper flange of the I-shaped roofing connector 98 extends over a top surface of the roofing sheets 62, thereby connecting the adjoining roofing sheets 62 together.

Referring to FIGS. 15 and 16, a spacer bracket 100 is disposed between and connects the first U-shaped roofing connector 88 and the second I-shaped roofing connector 98 at each of the ribs 86 of the roofing sheet 62 to reinforce the roof 82 system. The spacer bracket 100 may be attached to the U-shaped roofing connector 88 and the I-shaped roofing connector 98 by any suitable method appropriate for the materials utilized in the U-shaped roofing connector 88 and the I-shaped roofing connector 98. Suitable methods of attaching the spacer bracket 100 to the U-shaped roofing connector and the I-shaped roofing connector may include a plurality of threaded fasteners, an adhesive, welding, or some other method known in the art. The roofing connector 88, the second I-shaped roofing connector 98, and the spacer bracket 100, may comprise a hard plastic material, a metal material, or some other rigid material suitable for supporting the plurality of roofing sheets 62.

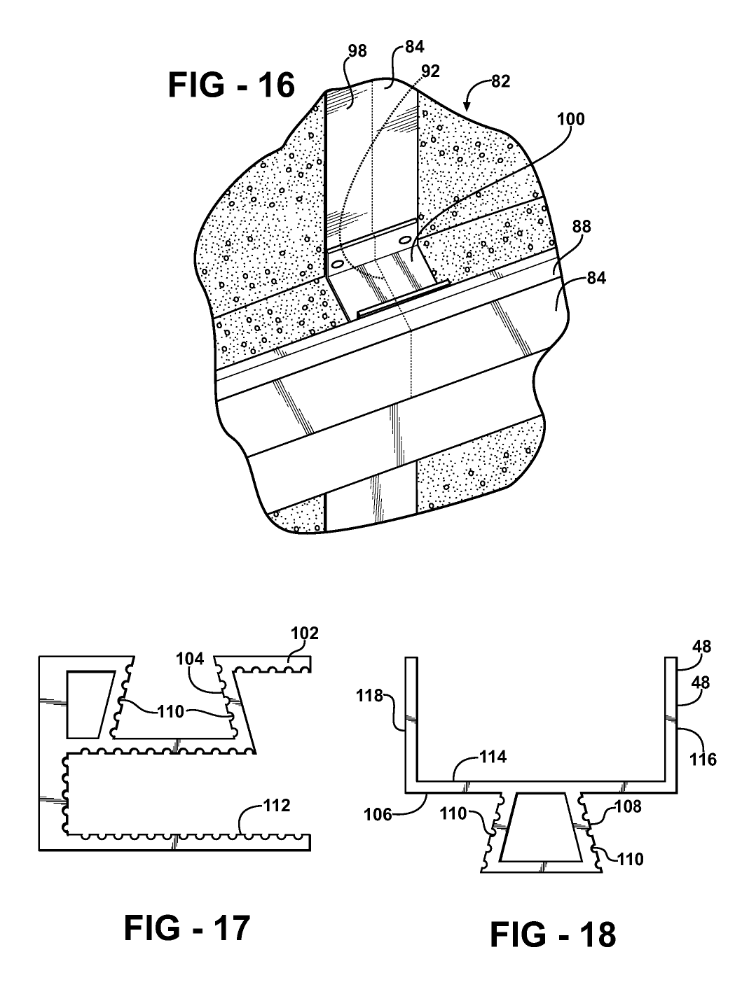

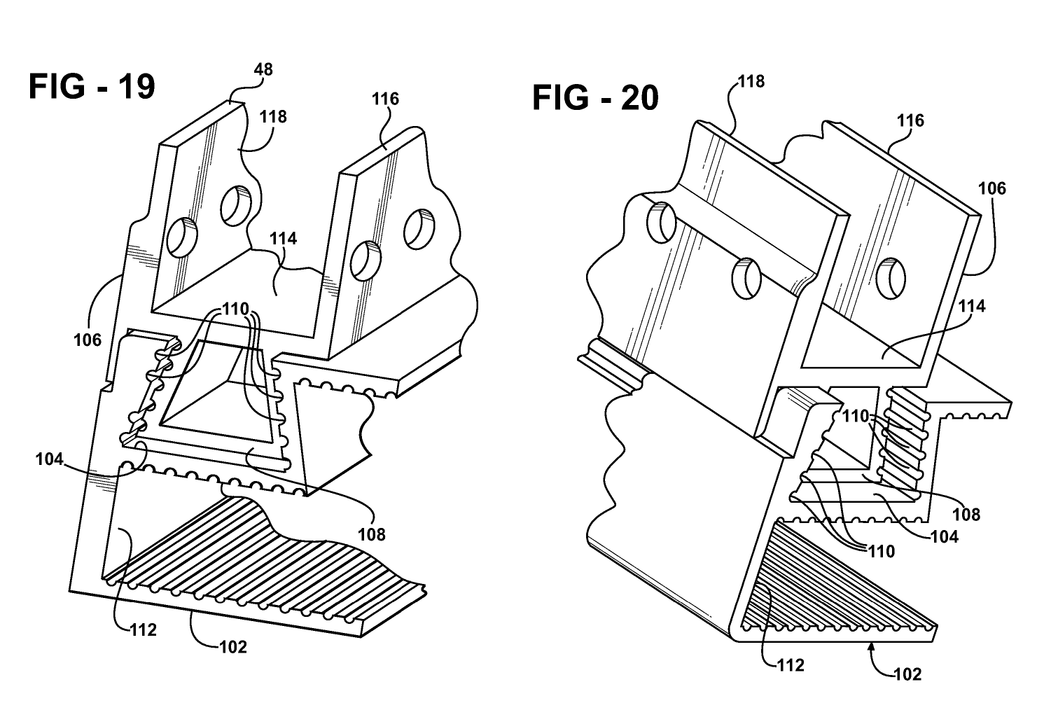

Referring to FIGS. 5 and 17, a first elongated bracket 102 is mounted to one of the floor 28 and the structural wall 30 for connecting the floor 28 to the structural wall 30. As shown in the Figures, the first elongated bracket 102 is mounted to the floor 28. The first elongated bracket 102 defines a female channel 104. Referring to FIGS. 2, 3, 4 and 18, a second elongated bracket 106 is mounted to the other of the floor 28 and the structural wall 30, and defines a male projection 108 complimentary in configuration to the female channel 104. As shown in the Figures, the second elongated bracket 106 is mounted to the structural wall 30. As best shown in FIGS. 19 and 20, the male projection 108 is disposed within the female channel 104 in interlocking engagement with the female channel 104, and securely connects the floor 28 and the structural wall 30. The first elongated bracket 102 and the second elongated bracket 106 extend the length of the structural wall 30, i.e., each wall segment will have a corresponding length of the first and second elongated brackets 102, 106 to interconnect each wall segment to the floor 28 along the entire length of the wall segment. It should be understood that the second elongated bracket 106 may be integrally formed with the sill plate 48. It should also be understood that if the second elongated bracket 106 is not integral formed with the sill bracket 48, then either the first elongated bracket 102 or the second elongated bracket 106 may be attached to the structural wall 30, with the other of the first elongated bracket 102 and the second elongated bracket 106 attached to the floor 28.

At least one of the female channel 104 and the male projection 108 define a plurality of grooves 110 extending along a length of the first elongated bracket 102 and the second elongated bracket 106. It is also contemplated that both the female channel 104 and the male projection 108 include the plurality of grooves 110. The plurality of grooves 110 permit a sufficient quantity of an adhesive to be disposed along the entire length of the connection interconnecting the first elongated bracket 102 and the second elongated bracket 106 to adequately bond the male projection 108 to the female channel 104.

Referring to FIGS. 17, 19, and 20, the first elongated bracket 102 defines a floor support channel 112 for supporting an outer edge of the floor 28 thereon. Preferably, the foam center 64 of the floor 28 is molded into the floor support channel 112 of the first elongated bracket 102 to mount the first elongated bracket 102 to the floor 28. This may be accomplished, for example, by placing the first elongated bracket 102, the upper support sheet 56 and the lower support sheets 58 into a mold, and injecting the foam therebetween to form the foam center 64 of the floor 28 about the floor support channel 112 of the first elongated bracket 102 and between the upper and lower support sheets 56, 58.

Referring to FIGS. 18 through 20, the second elongated bracket 106 of each wall segment includes a bottom member 114, an inner vertical member 116 and an outer vertical member 118. The inner vertical member 116 and the outer vertical member 118 extend from the bottom member 114, and define a U-shaped channel between the bottom member 114, the inner vertical member 116, and the outer vertical member 118. The U-shaped channel receives the sill plate 48 and a portion of the plurality of studs 52 therein so that the inner vertical member 116 and the outer vertical member 118 may be attached to the studs 52 to secure the second elongated bracket 106 to the studs 52.

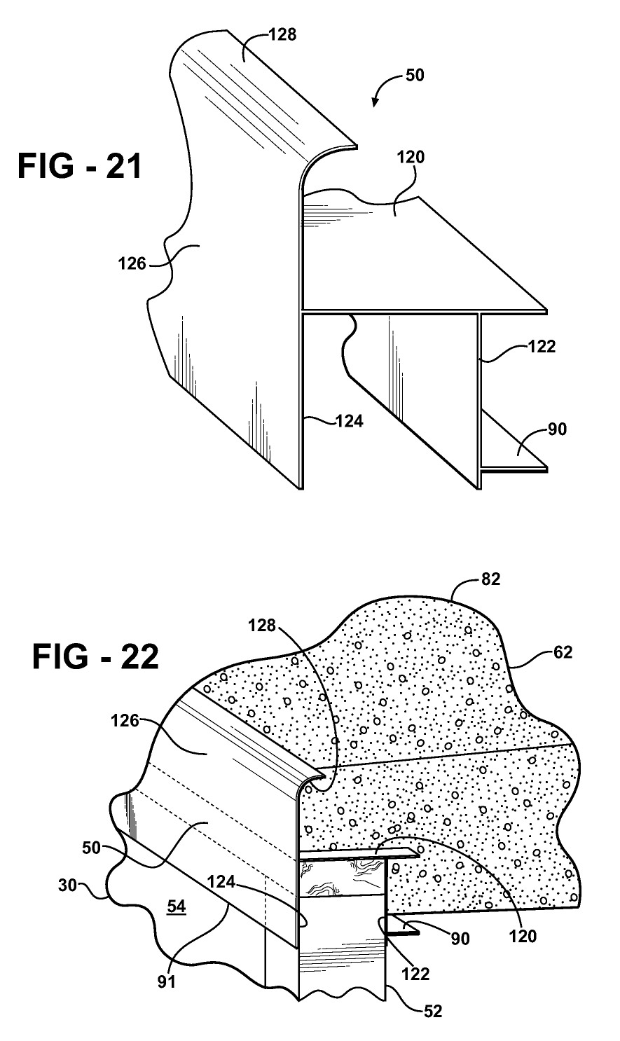

Referring to FIG. 21, the roof bracket 91 of each wall segment includes a roof support wall 120, an inner vertical wall 122 and an outer vertical wall 124. The inner vertical wall 122 and the outer vertical wall 124 extend from the roof support wall 120, and define a U-shaped channel between the roof support wall 120, the inner vertical wall 122, and the outer vertical wall 124. The U-shaped channel receives the top plate 50 and a portion of the plurality of studs 52 therein so that the inner vertical wall 122 and the outer vertical wall 124 may be attached to the studs 52 to secure the roof bracket 91 to the studs 52.

As shown in FIGS. 21 and 22, the roof bracket 91 includes an outer wall 126 extending from the roof support wall 120 to a distal retention end 128 spaced from the roof support wall 120. The retention end 128 is in interlocking engagement with the roof 82 to secure the roof 82 and the roof bracket 91 together in interlocking engagement. As shown, the retention end 128 includes a curvilinear shape to hook over the top surface of the roof 82 to restrain the roof 82 both laterally and vertically relative to the structural wall 30. It should be understood that the retention end 128 may be configured other than described herein and still fall with in the scope of the claims.

The roof bracket 91, the first elongated bracket 102, and the second elongated bracket 106 preferably comprise a rigid material such as a hard plastic material, a metal material. The metal material is preferably aluminum, but may comprise some other suitable metal such as steel. It should be appreciated that the roof bracket 91, the first elongated bracket 102, and the second elongated bracket 106 may all comprise the same material, or may all comprise different materials i.e., the roof bracket 91, the first elongated bracket 102, and the second elongated bracket 106 may all be manufactured from the same material or from different materials.

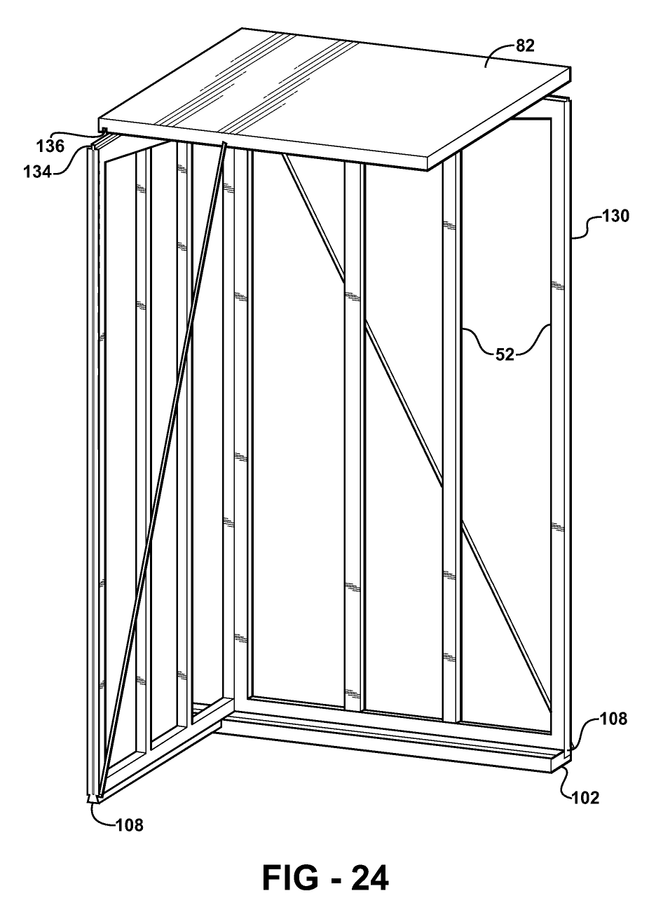

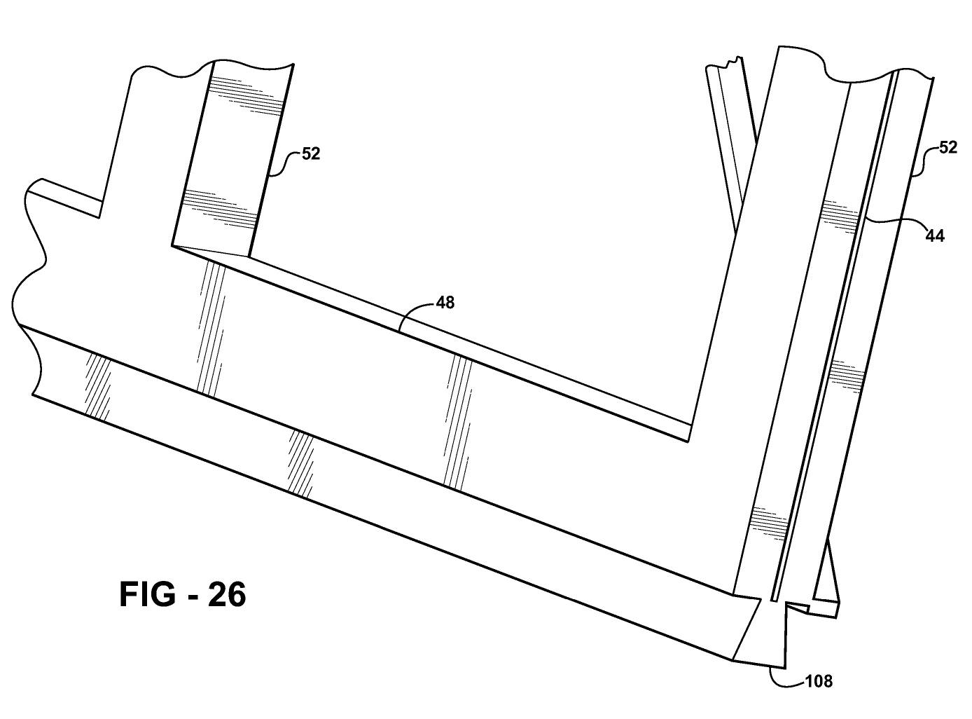

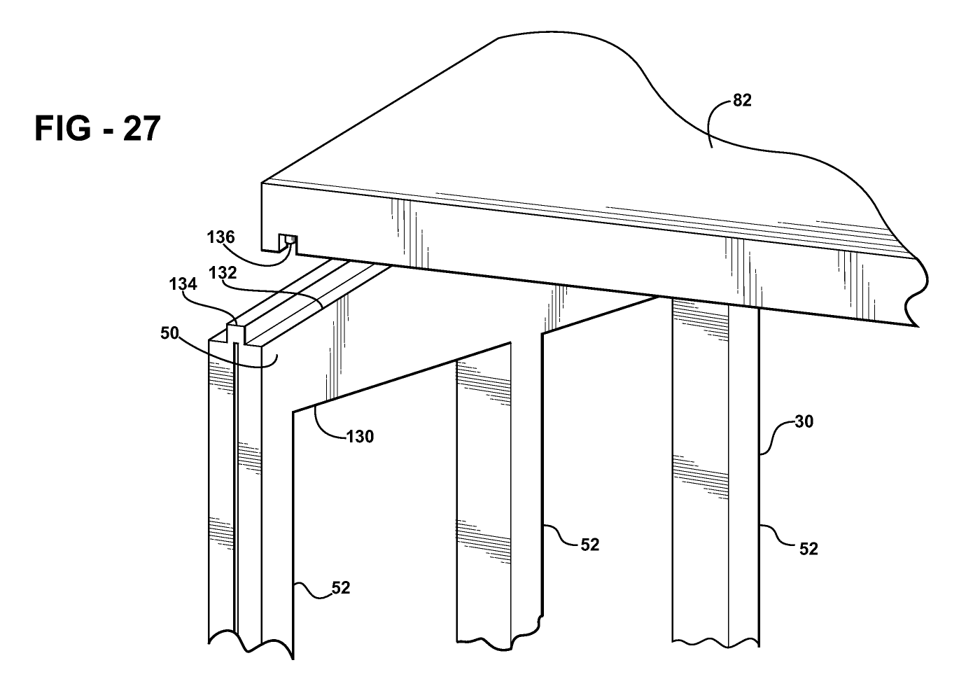

An alternative embodiment of the slide-out structure 26 is shown in FIGS. 24 through 27. As depicted in the alternative embodiment, the structural wall 30 includes a rectangular portion 130 and an angled portion 132 disposed between the rectangular portion 130 and the roof 82. The angled portion 132 of the structural wall 30 supports the roof 82 in a non-parallel relationship relative to the floor 28, i.e., the angled portion 132 provides a slope to the roof 82 relative to the floor 28.

As is shown in the alternative embodiment, the top plate 50 includes a tongue 134, with the roof 82 defining an interlocking groove 136 having a shape complimentary to the tongue 134. The tongue 134 is disposed within the interlocking groove 136 for connecting the structural wall 30 and the roof 82. The roof 82 is bonded to the header bracket 50 by an adhesive disposed within the tongue 134 and groove 110 connection, or by some other mechanical connection, such as by screws, bolts, etc.

The foregoing invention has been described in accordance with the relevant legal standards; thus, the description is exemplary rather than limiting in nature. Variations and modifications to the disclosed embodiments may become apparent to those skilled in the art and do come within the scope of the invention. Accordingly, the scope of legal protection afforded this invention can only be determined by studying the following claims.

What is claimed is:

1. A vehicle comprising:
a body defining an opening;
a slide-out structure disposed within said opening and moveable laterally relative to said body with said slide-out structure including a floor and a structural wall extending from said floor;
said structural wall including a sill plate, a top plate, and a plurality of studs extending between said sill plate and said top plate;
a first elongated bracket mounted to one of said floor and said structural wall and defining a female channel;
a second elongated bracket mounted to one of said floor and said structural wall and defining male projection complimentary in configuration to said female channel and disposed within said female channel in interlocking engagement with said female channel for connecting said floor and said structural wall.

2. A vehicle as set forth in claim 1 wherein at least one of said female channel and said male projection define a plurality of grooves extending along a length of said first elongated bracket and said second elongated bracket.

3. A vehicle as set forth in claim 1 wherein said second elongated bracket includes a bottom member, an inner vertical member and an outer vertical member extending from said bottom member and defining a U-shaped channel between said bottom member and said inner vertical member and said outer vertical member for receiving said structural wall therein.

4. A vehicle as set forth in claim 1 further comprising a roof bracket including a roof support wall, an inner vertical wall and an outer vertical wall extending from said roof support wall and defining a U-shaped channel between said roof support wall, said inner vertical wall, and said outer vertical wall for receiving said structural wall therein.

5. A vehicle as set forth in claim 1 wherein said structural wall includes a plurality of panels positioned adjacent each other along a plane with each of said plurality of panels including a first side edge and a second side edge each defining a slot extending along a height of each of said plurality of panels.

6. A vehicle as set forth in claim 5 wherein said structural wall includes a spline partially disposed within each of said slots of said adjacent plurality of panels to interconnect said adjacent plurality panels.

7. A vehicle as set forth in claim 1 further comprising a foam core disposed between said sill plate and said top late and said plurality of studs.

8. A vehicle as set forth in claim 7 wherein said foam core at least partially encapsulates, said sill plate, said top plate and said plurality of studs.

9. A vehicle as set forth in claim 1 wherein said slide-out structure includes a roof in spaced relationship relative to said floor and said structural wall includes a rectangular portion and an angled portion disposed between said rectangular portion and said roof for supporting said roof in a non-parallel relationship relative to said floor.

10. A vehicle as set forth in claim 4 wherein said roof bracket comprises a plastic.

11. A vehicle as set forth in claim 4 wherein said roof bracket comprises a metal.

12. A vehicle as set forth in claim 1 wherein said first elongated bracket comprises a plastic.

13. A vehicle as set forth in claim 1 wherein said first elongated bracket comprises a metal.

14. A vehicle as set forth in claim 1 wherein said second elongated bracket comprises a plastic.

15. A vehicle as set forth in claim 1 wherein said second elongated bracket comprises a metal.

16. A vehicle as set forth in claim 1 wherein said structural wall includes a covering layer.

17. A vehicle as set forth in claim 4 wherein said slide-out structure includes a roof in spaced relationship relative to said floor.

18. A vehicle as set forth in claim 17 wherein said roof bracket includes a tongue and said roof defines an interlocking groove having a shape complimentary to said tongue with said tongue disposed within said interlocking groove for connecting said structural wall and said roof.

19. A vehicle as set forth in claim 17 wherein said roof bracket includes an outer wall extending from said roof support wall to a retention end spaced from said roof support wall with said retention end in interlocking engagement with said roof.

20. A vehicle as set forth in claim 17 wherein said roof comprises a foam.

21. A vehicle as set forth in claim 17 wherein said roof includes a plurality of roofing sheets and wherein said vehicle further comprises a roofing connector interconnecting said plurality of roofing sheets.

22. A vehicle as set forth in claim 21 wherein said plurality of roofing sheets each include a plurality of ribs in spaced relationship extending across a width of each of said plurality of roofing sheets.

23. A vehicle as set forth in claim 22 wherein said roof bracket includes a ledge for supporting said roofing connector thereon.

24. A vehicle as set forth in claim 23 wherein said roofing connector includes a first roofing connector having a U-shaped cross section seated on said ledge for supporting at least one rib of said plurality of roofing sheets therein.

25. A vehicle as set forth in claim 24 wherein said roofing connector includes a second roofing connector having an I-shaped cross section.

26. A vehicle as set forth in claim 25 wherein each rib of said plurality of roofing sheets includes a thickened edge and an alignment slot extending through each rib at said thickened edge with a portion of said second I-shaped roofing connector disposed within said alignment slot for interconnecting said plurality of adjoining roofing sheets.

27. A vehicle as set forth in claim 26 further comprising a spacer bracket disposed between and connecting said first U-shaped roofing connector and said second I-shaped roofing connector.

28. A vehicle as set forth in claim 1 wherein said floor comprises a foam center.

29. A vehicle as set forth in claim 28 wherein said floor includes a support encapsulated within said foam center.

30. A vehicle as set forth in claim 29 wherein said floor includes an upper support sheet and a lower support sheet sandwiching said foam center therebetween.

31. A vehicle as set forth in claim 30 wherein said floor includes a plurality of flooring sheets adjacent each other.

32. A vehicle as set forth in claim 31 wherein each of said plurality of flooring sheets includes a first lateral edge and a second lateral edge and wherein said floor further comprises a flooring connector interconnecting said first lateral edge and said second lateral edge of said adjacent plurality of flooring sheets.

33. A vehicle as set forth in claim 32 wherein one of said first lateral edge and said second lateral edge includes a lateral notch and one of said first lateral edge and said second lateral edge includes a lateral ridge having a shape complimentary to said lateral notch with said lateral notch and said lateral ridge of said adjacent plurality of flooring sheets in interlocking engagement.

34. A vehicle as set forth in claim 30 further comprising a mounting plate attached to said floor.

35. A vehicle as set forth in claim 34 further comprising an extension mechanism coupled to said mounting plate for moving said slide-out structure laterally relative to said body.

36. A modular structure comprising:
a floor having a plurality of flooring sheets interconnected and comprising a foam center and a first support layer and a second support layer sandwiching said foam center therebetween;
a structural wall extending from said floor and including a plurality of panels each including a sill plate, a top plate and a plurality of studs extending between said sill bracket and said header bracket;
a roof in spaced relationship relative to said floor;
a roof bracket interconnecting said structural wall and said roof;
a first elongated bracket mounted to one of said floor and said structural wall and defining a female channel;
a second elongated bracket mounted to one of said floor and said structural wall and defining a male projection complimentary in configuration with said female channel and disposed within said female channel in interlocking engagement with said female channel for connecting said floor and said structural wall.

37. A structure as set forth in claim 35 wherein at least one of said female channel and said male projection define a plurality of grooves extending along a length of said first elongated bracket and said second elongated bracket.

38. A structure as set forth in claim 36 wherein said second elongated bracket includes a bottom member, an inner vertical member and an outer vertical member extending from said bottom member and defining a U-shaped channel between said bottom member and said inner vertical member and said outer vertical member for receiving said plurality of studs therein.

39. A structure as set forth in claim 36 wherein said roof bracket includes a roof support wall, an inner vertical wall and an outer vertical wall extending from said roof support wall and defining a U-shaped channel between said roof support wall, said inner vertical wall, and said outer vertical wall for receiving said plurality of studs therein.

40. A structure as set forth in claim 36 wherein each of said plurality of panels includes a first side edge and a second side edge each defining a slot extending along a height of each of said plurality of panels.

41. A structure as set forth in claim 40 wherein said structural wall includes a spline partially disposed within each of said slots of said adjacent plurality of panels to interconnect said adjacent plurality panels.

42. A structure as set forth in claim 36 further comprising a foam core disposed between said sill plate and said top plate and said plurality of studs.

43. A structure as set forth in claim 42 wherein said foam core at least partially encapsulates, said sill plate, said top plate and said plurality of studs.

44. A structure as set forth in claim 36 wherein said roof bracket comprises a plastic.

45. A structure as set forth in claim 36 wherein said roof bracket comprises a metal.

46. A structure as set forth in claim 36 wherein said first elongated bracket comprises a plastic.

47. A structure as set forth in claim 36 wherein said first elongated bracket comprises a metal.

48. A structure as set forth in claim 36 wherein said second elongated bracket comprises a plastic.

49. A structure as set forth in claim 36 wherein said second elongated bracket comprises a metal.

50. A structure as set forth in claim 36 wherein said structural wall includes a covering layer.

51. A structure as set forth in claim 39 wherein said roof bracket includes an outer wall extending from said roof support wall to a retention end spaced from said roof support wall with said retention end in interlocking engagement with said roof.

52. A structure as set forth in claim 36 wherein said roof includes a plurality of roofing sheets.

53. A structure as set forth in claim 52 wherein said plurality of roofing sheets comprise a foam.

54. A structure as set forth in claim 52 further comprising a roofing connector interconnecting said plurality of roofing sheets.

55. A structure as set forth in claim 52 wherein said plurality of roofing sheets each include a plurality of ribs in spaced relationship extending across a width of each of said plurality of roofing sheets.

56. A structure as set forth in claim 55 wherein said header bracket includes a ledge for supporting said roofing connector thereon.

57. A structure as set forth in claim 56 wherein said roofing connector includes a first roofing connector having a U-shaped cross section seated on said ledge for supporting at least one rib of said plurality of roofing sheets therein.

58. A structure as set forth in claim 57 wherein said roofing connector includes a second roofing connector having an I-shaped cross section.

59. A structure as set forth in claim 58 wherein each rib of said plurality of roofing sheets includes a thickened edge and an alignment slot extending through each rib at said thickened edge with a portion of said second I-shaped roofing connector disposed within said alignment slot for interconnecting said plurality of adjoining roofing sheets.

60. A structure as set forth in claim 59 further comprising a spacer bracket disposed between and connecting said first U-shaped roofing connector and said second I-shaped roofing connector.

61. A structure as set forth in claim 36 wherein said floor includes a support encapsulated within said foam center.

62. A structure as set forth in claim 36 wherein each of said plurality of flooring sheets includes a first lateral edge and a second lateral edge and wherein said floor further comprises a flooring connector interconnecting said first lateral edge and said second lateral edge of said adjacent plurality of flooring sheets.

63. A structure as set forth in claim 62 wherein one of said first lateral edge and said second lateral edge includes a lateral notch and one of said first lateral edge and said second lateral edge includes a lateral ridge having a shape complimentary to said lateral notch with said lateral notch and said lateral ridge of said adjacent plurality of flooring sheets in interlocking engagement.
